(19) United States
(12) Patent Application Publication
(10) Pub. No.: US 2006/0085257 A1
(43) Pub. Date: Apr. 20, 2006

(54) A METHOD FOR LEVERAGING A COMPANY'S BRAND

(76) Inventor: Cynthia D. Johnson, Milwaukee, WI (US)

Correspondence Address: Alozie N. Etufugh, Esq.;Law Offices of Alozie N. Etufugh, PLLC, Suite 4D, 30 Central Park South, New York, NY, 10019, US

(21) Appl. No.: 11/251,201

(22) Filed: Oct. 14, 2005

Related U.S. Application Data
(60) Provisional application No. 60/618,957, filed on Oct. 14, 2004.

(51) Int. Cl. G06Q 30/00

(52) U.S. Cl. 705/14

(57) ABSTRACT

A method of interactive advertising in which a customer contacts a system for a particular product or service. The customer provides information and the system determines the appropriate advertising for the customer based on the information provided. The customer is able to place an order for products or services advertised once the customer expresses interest in first the advertisement and then the product or service. The system then processes the customer's order.

### CROSS REFERENCE TO RELATED APPLICATIONS

This application is a non-provisional application conversion for provisional application Ser. No. 60/618,957 filed Oct. 14, 2004 by Cynthia D. Johnson.

### TECHNICAL FIELD OF THE INVENTION

The present invention relates generally to interactive advertising. More specifically, leveraging the value of a company's brand in advertising products and services.

### BACKGROUND OF THE INVENTION

With advances in technology, companies are limited in their ability to reach out to customers regarding their products or services. Consumers have an overwhelming choice of entertainment and programming options, which all vie for their time and attention. As a result, consumers are more apt to try to avoid this advertising “onslaught”. In this regard, several devices have been created in order to allow consumers to enjoy their media while avoiding unsolicited advertising presentations. For instance, the development of digital video recording devices such as the ubiquitous “TiVo” device have presented challenging obstacles for consumer companies seeking to reach key audiences or demographics. In addition, TiVo-like devices will soon be used to capture subscription-based digital radio programming thereby casting a dark cloud over the future of traditional broadcast radio and radio advertising.

Companies now seek innovative ways to circumvent obstacles to their advertising campaigns. Consequently, companies are willing to pay what it takes to reach their targeted demographics. For instance, some companies have begun using “Webisodes” to connect with consumers. Other companies have adopted “grass roots” efforts in order to win new customers.

A company's powerful brand along with phone, data systems and other forms of communication could provide the audience sought by these companies and allow for the effective targeting of interested customers. The audience in this instance may comprise of a company's existing and prospective customers, for example, existing or prospective policyholders of an insurance company. A well-crafted system of utilizing existing customers along with integration with phone lines, data systems or other forms of communication all coupled with the effect and strength of a host company's brand presents an alternative to the traditional forms of advertising. One component of the system may be used to determine when customers are most attentive or receptive to advertising.

### SUMMARY OF THE INVENTION

Accordingly, it is an advantage of the present invention to enable companies' advertising to reach existing or potential pools of interested customers.

An additional advantage of the present invention is that it allows for the efficient use of a company's existing or prospective customers.

A further advantage of the present invention is that companies are able to derive revenue from the improved advertising system/scheme by way of third-party subscribers and the like.

An even further advantage of the present invention is that existing customers are protected from being harassed by advertisers as the process will be appropriately controlled and customers will have a choice as to whether they want to be exposed to certain advertising or offer presentations.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a flow chart showing a customer's interaction with the system in accordance with the invention.

FIG. 2 is a flow chart showing another example of a customer's interaction with the system in accordance with the present invention.

FIG. 3 is a flow chart showing another example of a customer's interaction with the system in accordance with the invention.

FIG. 4 is a flow chart showing a hosting company's internal operations in the system in accordance with the invention.

### DESCRIPTION OF THE PREFERRED EMBODIMENT (S)

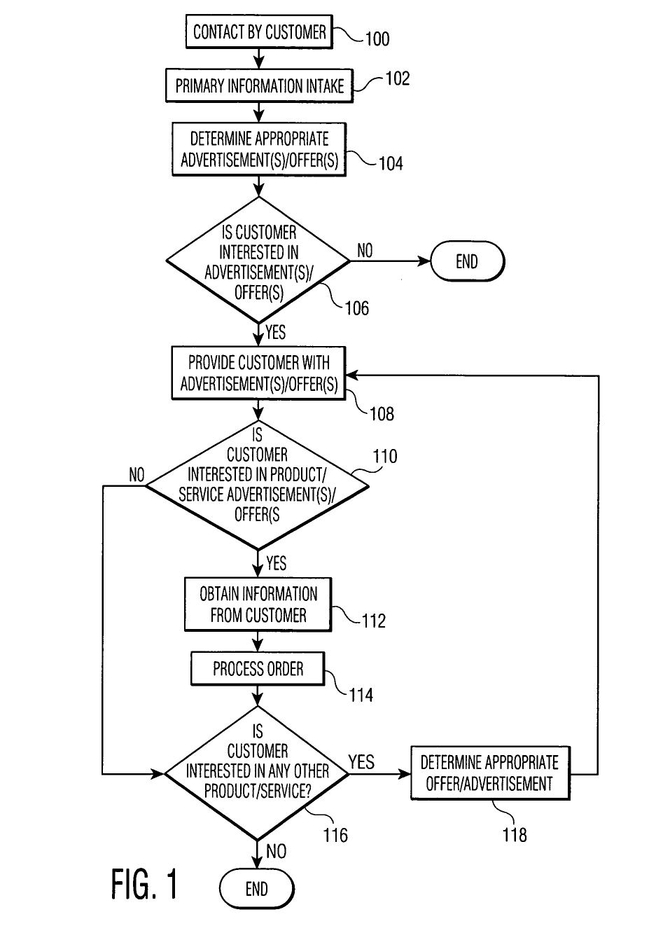

By reference to the exemplary drawings in detail wherein like numerals indicate like steps throughout the various views, FIG. 1 shows the present invention with respect to a customer interaction in accordance with the invention.

The preferred exemplary embodiment of the invention will be described in conjunction with the appended drawing, wherein like designations denote like elements or steps, etc.

In FIG. 1, the customer contacts the company in step 100 and the system obtains primary information from the customer (step 102). This initial information may vary depending on the type of business. It could be the customer's personal information, address, phone number etc. Once the information is obtained, the system determines the appropriate advertisement or offer to present to the customer (step 104). The system's determination may be based on the information provided by the customer in step 102. For instance, the determination may be based on a customer's zip code in which case, the system will present the customer with discounted offers from businesses in that particular or surrounding zip codes. Once the system decides the appropriate advertisement or offer for the customer, the customer is given the opportunity to decide whether they want to be presented with the advertisement or offer (step 106). If the customer declines the process ends. If the customer agrees, the customer is then presented with an advertisement or offer (step 108). After the advertisement or offer is presented, the customer is given the option to express his/her interest in the product/service being advertised (asked if they want to purchase the product or service) (step 110). If the customer wants the product/service, the system then fills the order (step 114) having obtained another set of information (step 112) from the customer if the previously obtained information is not sufficient for fulfilling the order. If the customer is not interested in the product/service, the customer is asked if they need any other product/service (step 116). If the customer does not need any additional product/service, the process ends. If the customer wants an additional product/service, the system determines the appropriate offer/advertisement based on the information obtained from the customer (step 118) and reverts to step 108 where the customer is presented with the advertisement or offer selected in step 118. The cycle (step 118 through 116) continues until the customer decides that he/she does not want to order a product or service. Referring back to step 110, if the customer is not interested the system then asks the customer if he/she is interested in any additional products/services (step 116). If the customer is not interested, the process ends.

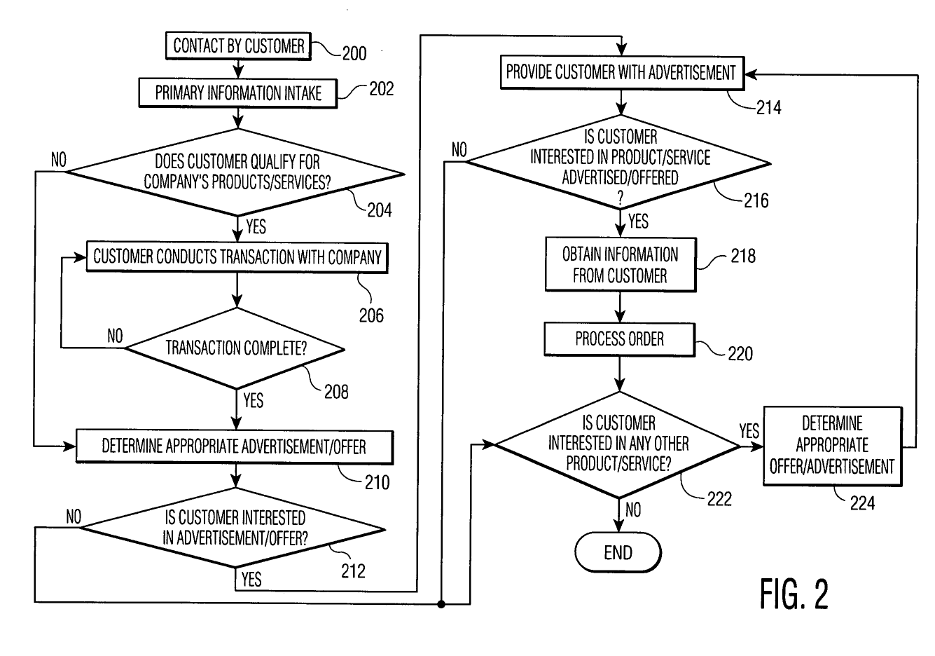

FIG. 2 shows a flow chart in accordance with the invention. A customer contacts the company's system in step 200. The system then obtains initial information from the customer (step 202) and determines whether the customer is qualified for the company's products/services (step 204). This qualification may be based on the information obtained from the customer. If the customer is qualified for the company's products/services, the customer is allowed to conduct his/her transaction with the company (step 206). If the customer does not qualify for the company's products/services, the system determines the appropriate advertisement or offer for the customer (step 210) (the determination is based on the information obtained from the customer). Referring back to step 206, once the customer completes his/her transaction with the company, the system checks to confirm whether the customer has completed his/her transaction with the company (step 208). If the transaction has been completed, the system then determines the appropriate advertisement or offer for the customer (step 210) based on the subject matter of the completed transaction and the information previously provided by the customer. For instance, if the customer called in with an auto claim, the system may determine to present the customer with an advertisement relating to an auto loan. If the transaction is not complete (step 208), the system reverts to step 206 until all transactions are complete. After the system has determined the appropriate advertisement or offer (step 210), the customer is asked whether he/she is interested in being presented with an offer or advertisement (step 212). If the customer is interested, the customer is provided with an advertisement or offer (step 214) and then asked if he/she is interested in the product/service advertised i.e. if they want to order the product/service (step 216). If the customer is interested in ordering, the system obtains information from the customer (step 218) if the information previously obtained is not sufficient or if it was not relevant to filling the customer's order. The customer's order is then filled (step 220) and the customer is asked if he/she needs any additional products/services (step 222). If the customer needs another product/service then the system determines an appropriate offer or advertisement to present (step 224). If the customer is not, the process ends. Referring back to step 212, if the customer is not interested in either an offer or an advertisement, the system asks the customer if he/she is interested in some other product/service (step 222). If the customer is not interested the process ends. If the customer is interested, the system proceeds to step 224 and the loop (step 224 through 222) continues until the customer indicates that he/she is not interested in any product/service.

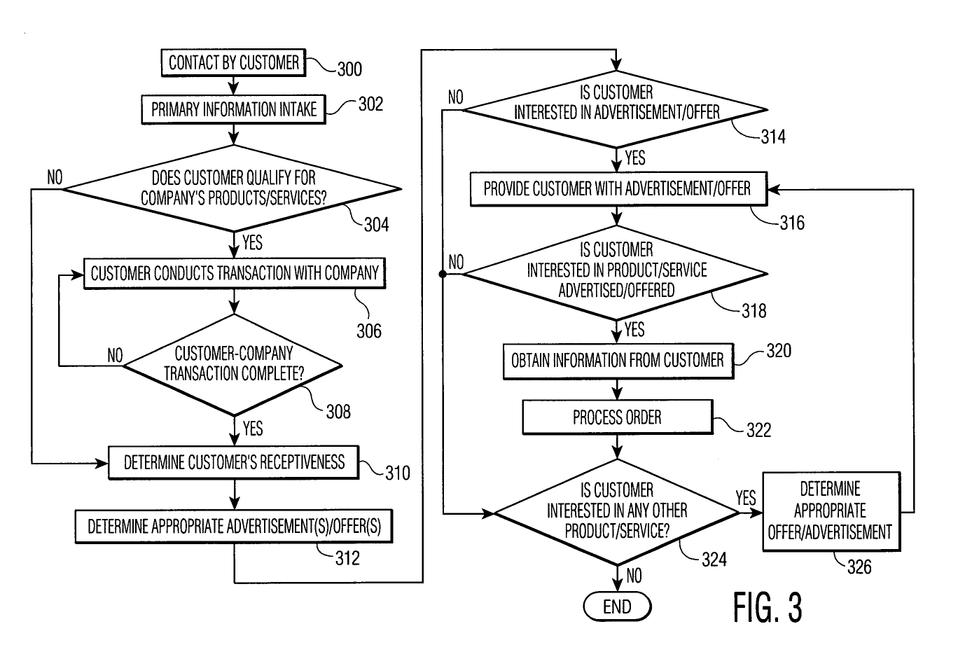

FIG. 3 is a flow chart in accordance with the invention. The customer contacts the company's system (step 300) and provides initial information (step 302). The system then determines whether the customer qualifies for any of the company's products/services (step 304). If the customer qualifies, the customer is allowed to conduct his/her transaction with the company (step 306). If the customer fails to qualify for the company's products/services, the system then determines the customer's receptiveness to receiving an advertisement or an offer (step 310). This determination may be made in a number of ways including factoring the strength of the company's brand (i.e. determining what kinds of products or services are on the same quality or cost level as the host company), determining the customer's demographic (based on the information provided by the customer), or by any other method. Referring back to step 306, the system checks to see if the customer has completed his/her transaction with the company (step 308) after which the system checks the customer's receptiveness (step 310) at which point the system then (in its determination of the customer's receptiveness) may consider the products or services related to the transaction conducted by the customer in addition to some other factors. Next, the system determines the appropriate advertisement or offer to present to the customer (step 312) and the customer is asked if he/she would be interested in being presented with the advertisement or offer (step 314). If the customer is interested, the system then provides the customer with the advertisement or offer (step 316) and the customer has the choice of ordering or declining the order for the product/service presented (step 318). If the customer decides to order or is interested, the system obtains information from the customer (step 320) if the information previously obtained is not sufficient or if it was not relevant to filling the customer's order. The order is then filled (step 322) and the customer is asked if he/she is interested in any additional product/service (step 324). Referring back to step 314, if the customer is not interested in the advertisement or offer presented, he/she is asked if interested in any additional product/service (step 324). If not, the process ends. If so, then the system determines the appropriate offer or advertisement (step 326) and the process (steps 326 through 324) continues until the customer indicates that he/she is not interested in any more products/services.

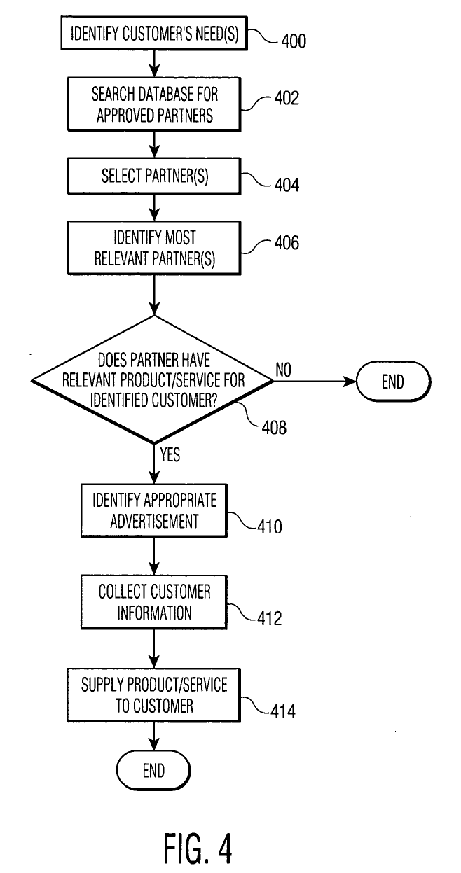

FIG. 4 is a flow chart showing a company's system operation in accordance with the invention. The system first identifies a customer's need (step 400). This may be done by accessing information provided by the customer or by accessing existing databases of customer requests/needs. The system then searches the database for approved partners (step 402). These partners are companies that have agreements with the host company for the host company to offer their promotions, products or services to its customers. The host company may obtain a fee from these partners for granting these third-party advertiser access. After identifying the approved partners, the system then selects the most relevant partners (steps 404 and 406). The system then matches the customer's needs with the products/services offered (step 408). If there is no match, the process ends. If there is a match, the system then identifies the appropriate advertisement or offer (step 410) and then collects information from the customer (step 412) (if the system does not have adequate information to fulfill an order). Finally, the system makes provisions for supplying the product/service to the customer (step 414).

The system, as described above, may be implemented by a processor or computer operated program that routinely and automatically conducts the tasks above or it could be an individual authorized to conduct the tasks above. Additionally, during an interactive voice call session, the system may leverage information already in the company's system regarding the customer or potential customer, such as zip code or area code, to more accurately target the available system advertisements in real time or to determine the eligibility of the individuals for offers by other companies. For example, if an existing customer or potential customer calls an insurance company to request coverage or additional coverage and is determined not to be eligible, then the system could use his area code, provided either by an automatic number identification system or from a system database, or other system or provided information to determine his eligibility for a cellular phone offer.

Although this invention has been disclosed with reference to specific forms and embodiments, it will be evident that a great number of variations may be made without departing from the spirit and scope of the invention. These and other changes and modifications which are obvious to those skilled in the art are intended to be included within the scope of the present invention. For example, parts or steps may be reversed, equivalent elements may be substituted for those specifically disclosed, and certain features of the invention may be used independently of other features all without departing from the invention as defined in the appended claims.

What is claimed is:

1. A method of interactive advertising, comprising the steps of:
a. enabling contact by a customer;
b. obtaining primary information from the customer;
c. determining an appropriate advertisement for the customer;
d. querying the customer for interest in the advertisement;
e. presenting the advertisement to the customer;
f. determining customer interest in an initial product or service featured in the advertisement;
g. processing the customer's order and
h. determining whether the customer is interested in an additional product or service.

2. A method as disclosed in claim 1 further comprising the step of presenting the customer with an advertisement featuring the additional product.

3. A method as disclosed in claim 1 further comprising the step of presenting the customer with an advertisement featuring the additional service.

4. A method as disclosed in claim 3 wherein the additional service presented in the advertisement is directly related to the primary information obtained from the customer and where the additional service is required because of the content of the primary information.

5. A method as disclosed in claim 3 wherein the presented advertisement featuring the additional service is targeted based on one or more of pre-existing system information, information provided directly by the customer and automatically detected system information.

6. A method as disclosed in claim 1 wherein the processing step further comprises of the step of obtaining secondary information when additional information is required.

7. A method as disclosed in claim 6 further comprising the steps of:
a. qualifying a customer; and
b. conducting a transaction.

8. A method as disclosed in claim 7 further comprising the step of determining whether a customer is receptive to advertising.

9. A system for interactive advertising comprising:
a. a memory device; and
b. a processor disposed in communication with the memory device, the processor configured to:
i. enable contact by a customer;
ii. obtain primary information from the customer;
iii. determine an appropriate advertisement for the customer;
iv. query the customer for interest in the advertisement;
v. present the advertisement to the customer;
vi. determine customer interest in the subject of the advertisement;
vii. process the customer's order and
viii. determine whether the customer is interested in an additional product or service.

10. A system as disclosed in claim 9 wherein the processor is further configured to present an advertisement featuring the additional product.

11. A system as disclosed in claim 9 wherein the processor is further configured to present an advertisement featuring the additional service.

12. A system as disclosed in claim 9 wherein the processor is further configured to obtain secondary information when additional information is required.

13. A system as disclosed in claim 12 wherein the processor is further configured to:
a. qualify the customer; and
b. enable the customer to conduct a transaction.

14. A system as disclosed in claim 13 wherein the processor is further configured to determine whether the customer is receptive to advertising.

15. A computer readable medium comprising:
a. instruction code for enabling contact by a customer;
b. instruction code for obtaining primary information from the customer;
c. instruction code for determining an appropriate advertisement for the customer;
d. instruction code for querying the customer for interest in the advertisement;
e. instruction code for presenting the advertisement to the customer;
f. instruction code for determining customer interest the subject of the advertisement;
g. instruction code for processing the customer's order; and
h. instruction code for determining whether the customer is interested in an additional product or service.

16. A computer readable medium as disclosed in claim 15 further comprising instruction code for presenting the customer with an advertisement featuring the additional product.

17. A computer readable medium as disclosed in claim 15 further comprising instruction code for presenting the customer with an advertisement featuring the additional service.

18. A computer readable medium as disclosed in claim 15 further comprising instruction code for obtaining secondary information when additional information is required to process the customer's order.

19. A computer readable medium as disclosed in claim 18 further comprising:
a. instruction code for qualifying the customer; and
b. instruction code for enabling the customer to conduct a transaction.

20. A computer readable medium as disclosed in claim 19 further comprising instruction code for determining when a customer is receptive to advertising.
